(19) United States
(12) Patent Application Publication
(10) Pub. No.: US 2008/0024260 A1
(43) Pub. Date: Jan. 31, 2008

(54) ANTI-INTERFERENCE TRANSFORMER

(75) Inventors: Cheng-Chia HSU, Chupei City (TW); Teng-Kang CHANG, Jhudong Township (TW)

Correspondence Address: ROSENBERG, KLEIN & LEE, 3458 ELLICOTT CENTER DRIVE-SUITE 101, ELLICOTT CITY, MD, 21043, US

(73) Assignee: LOGAH TECHNOLOGY CORP., HSINCHU COUNTY (TW)

(21) Appl. No.: 11/835,012

(22) Filed: Aug. 7, 2007

Related U.S. Application Data
(63) Continuation-in-part of application No. 11/159,355, filed on Jun. 23, 2005.

(30) Foreign Application Priority Data
Jul. 16, 2004 (TW) 093211253

(51) Int. Cl. H01F 27/28

(52) U.S. Cl. 336/182

(57) ABSTRACT

An anti-interference transformer comprises a windings base, an I-shaped core, an E-shaped core and wires, wherein the windings base has a plurality of separating ribs disposed externally thereto so as to form a primary side-region and a secondary side-region and enables different wires to be wound between the separating ribs, and the windings base is structured with a hollow inside for receiving the I-shaped core and fits the E-shaped core on the outside thereof, so that a magnetic path is formed between the primary side-region and the secondary side-region and thus provides a leakage magnetic flux being free from leaking and controllable. The transformer of the present invention is designed with cores for forming additionally a magnetic path so as to achieve the purpose for anti-interference and to increase the stability of the related products in use.

### REFERENCE TO RELATED APPLICATIONS

This Application is a Continuation-in-Part of patent application Ser. No. 11/159,355, filed 23 Jun. 2005, currently pending.

### BACKGROUND OF THE INVENTION

1. Field of the Invention

The present invention relates to an anti-interference transformer and particularly to an anti-interference transformer for use in the backlight driver of a liquid crystal display (LCD), being designed with cores for forming additionally a magnetic path so as to achieve the purpose for anti-interference and to increase the stability of the related products.

2. Descriptions of the Related Art

FIG. 1A to 1C are top views of various conventional transformers used in the backlight driver of an LCD. As shown in FIG. 1A, a conventional transformer 1 consists of a windings base 11, E-shaped cores 12 and 13 and wires 14. The windings base 11 has a plurality of separating ribs 111 disposed externally thereto so as to form a primary side-region 15 and a secondary side-region 16 and enables different wires 14 to be wound between the separating ribs 111; the windings base 11 is structured with a hollow inside for receiving the E-shaped cores 12 and 13 so that the transformer 1 is formed. Nevertheless, the conventional transformer 1 would have a leakage magnetic flux ψ11 and a leakage magnetic flux ψ22 generated in the primary side-region 15 and the secondary side-region 16, respectively, and a leakage magnetic flux ψ12 generated between the primary side-region 15 and the secondary side-region 16. Those generated fluxes can be distributed in the free space and, therefore, lead to interference with external devices and the transformer may be susceptible to the influence of other magnetic devices so that it may have very unstable performance and the related product may become abnormal. Now refer to FIG. 1B, which shows a conventional transformer 1a formed with a combination of a C-shaped core 12a and an I-shaped core 13a. Such a structure of the conventional transformer 1a also suffers to the problem of magnetic leakage as above. Refer to FIG. 1C, which shows a conventional transformer lb formed with a combination of U-shaped cores 12b and 13b. Such a structure of the conventional transformer 1b also suffers to the problem of magnetic leakage as above.

Therefore, there are shortcomings in the conventional transformers. As those transformers are not well-designed, an improvement is required urgently.

In view of these problems encountered in the prior art, the Inventors have paid many efforts in the related research and finally developed successfully an anti-interference transformer used in a backlight driver of LCD, which is taken as the present invention.

### SUMMARY OF THE INVENTION

The primary objective of this invention is to provide an anti-interference transformer that is designed with cores for forming additionally a magnetic path, so as to achieve the purpose for anti-interference and to increase the stability of the related products.

Another objective of this invention is to provide an anti-interference transformer from which the leakage magnetic flux generated cannot lead to interference with any external device and the transformer cannot be susceptible to the influence of other magnetic devices, so as to promote the performance, to save the cost and to prolong the lifetime.

According to the present invention, an anti-interference transformer comprises a windings base, an I-shaped core, an E-shaped core and wires, wherein the windings base has a plurality of separating ribs disposed externally thereto so as to form a primary side-region and a secondary side-region and enables different wires to be wound between the separating ribs, and the windings base is structured with a hollow inside for receiving the I-shaped core and fits the E-shaped core on the outside thereof, so that a magnetic path is formed between the primary side-region and the secondary side-region and thus provides a leakage magnetic flux as being free from leaking and controllable.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A to 1C are top views of various conventional transformers used in the backlight driver of an LCD.

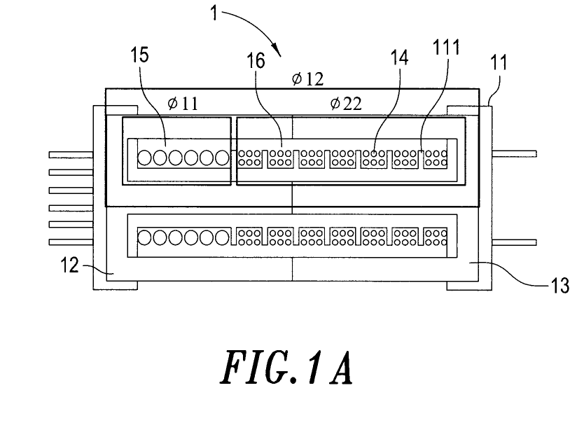

FIG. 2A is a structural top view of the anti-interference transformer according to the present invention.

FIG. 2B is a schematic diagram for the cores of this anti-interference transformer;

FIG. 3 is an equivalent schematic diagram for the circuitry configuration.

### DESCRIPTION OF THE PREFERRED EMBODIMENT

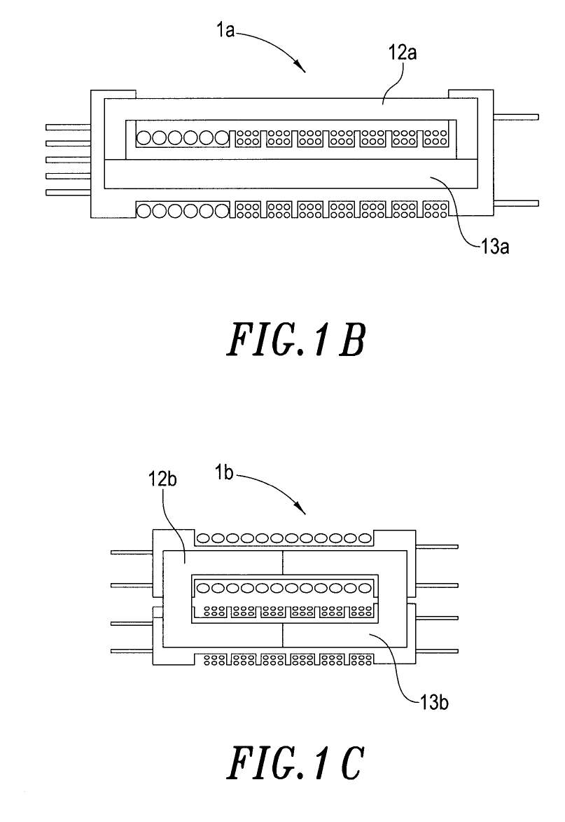

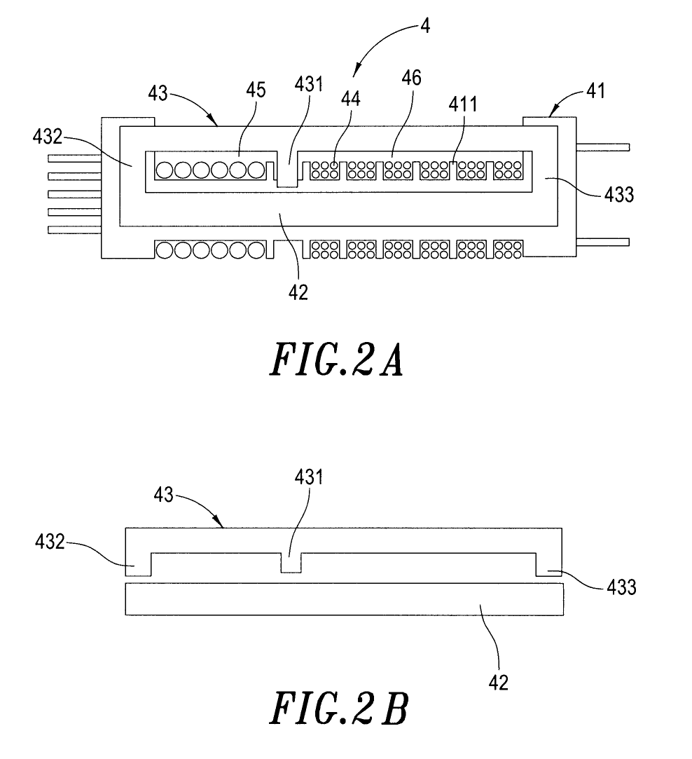

Refer to FIGS. 2A and 2B, which are, respectively, a structural top view of the anti-interference transformer and a schematic diagram for the cores of the anti-interference transformer according to the present invention. As shown in FIGS. 2A and 2B, the transformer 4 of the present invention comprises a windings base 41, an I-shaped core 42, an E-shaped core 43 and wires 44, wherein the windings base 41 has a plurality of separating ribs 411 disposed externally thereto so as to form a primary side-region 45 and a secondary side-region 46 and enables different wires 44 to be wound between the separating ribs 411, and the windings base 41 is structured with a hollow inside for receiving the I-shaped core 42 and fits the E-shaped core 43 on one side thereof, with the E-shaped core 43 having supporting arms 432, 433 each connected to one end of the I-shaped core 42 and a middle supporting arm 431 fixed between the primary side-region 45 and the secondary side-region 46 and disposed from the I-shaped core 42 by a spacing. As designed with the I-shaped core 42 and the E-shaped core 43, a magnetic path can be formed between the primary side-region 45 and the secondary side-region 46 and thus can provide a leakage magnetic flux being free from leaking and controllable so that the purpose for anti-interference can be achieved and the stability of the related products in use can be increased.

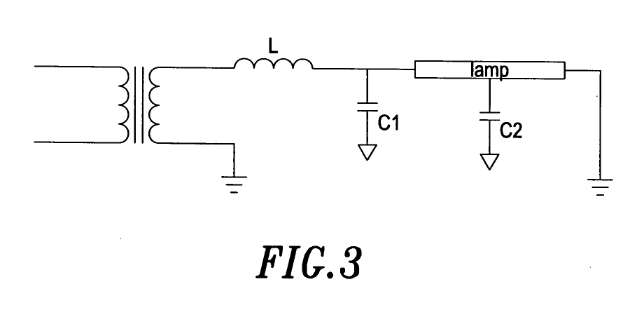

Refer to FIG. 3, which is an equivalent schematic diagram for the circuitry configuration. As shown in FIG. 3, the structure according to the present invention is featured for the purpose for an increase of the leakage inductance (L) to oscillate harmonically with the circuitry capacitance (C₁) and the tube capacitance (C₂), so as to start up the light tube.

The anti-interference transformer provided in the present invention, as compared with other conventional technologies, has the following advantages:

1. The anti-interference transformer is designed with cores for forming additionally a magnetic path so as to achieve the purpose for anti-interference and to increase the stability of the related products.

2. The anti-interference transformer is such that the leakage magnetic flux generated cannot lead to interference with any external device and the transformer cannot be susceptible to the influence of other magnetic devices, being advantaged in performance promotion, fabrication simplification, cost saving and lifetime prolongation.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An anti-interference transformer, comprising:
a windings base, having a plurality of separating ribs disposed externally thereto so as to form a primary side-region and a secondary side-region and enabling different wires to be wound between the separating ribs, and being structured with a hollow inside for receiving the I-shaped core;
an I-shaped core, being fixed in the windings base and having both ends each connected to one side supporting arm of the E-shaped core; and
an E-shaped core, being disposed on one side of the windings base and having the supporting arms each connected to one end of the I-shaped core and a middle supporting arms fixed between the primary side-region and the secondary side-region and disposed from the I-shaped core by a spacing.

2. The anti-interference transformer of claim 1, wherein the side supporting arms of the E-shaped core are each connected to one end of the I-shaped core by plane contact.
